(19) United States
(12) Patent Application Publication
(10) Pub. No.: US 2017/0115645 A1
(43) Pub. Date: Apr. 27, 2017

(54) APPARATUS AND METHOD FOR INTERFACING WITH SUPERVISORY MONITORING AND CONTROL ARRANGEMENTS

(71) Applicant: GE Intelligent Platforms, Inc., Charlottesville, VA (US)

(72) Inventors: Devon Spencer MERRITT, Edmonton (CA); Chad Craig SMITH, Edmonton (CA)

(21) Appl. No.: 14/921,330

(22) Filed: Oct. 23, 2015

(51) Int. Cl. G05B 19/042

(52) U.S. Cl. CPC G05B 19/042; G05B 2219/24215

(57) ABSTRACT

An electronic representation of a network and at least one equipment at the network is received. Intelligent electronic device (IED) information describing at least one IED is received. The at least one IED has an associated plurality of logical IED nodes. A map is created that associates the at least one equipment to an instance of a selected one of the plurality of logical IED nodes. A configuration interface is created and is based upon at least one of the electronic representation of the network, the IED information, and the map. The IED information and the configuration interface are generated automatically.

### BACKGROUND OF THE INVENTION

The subject matter disclosed herein relates to the supervisory monitoring and controlling of equipment.

### BRIEF DESCRIPTION OF THE RELATED ART

A Supervisory Control and Data Acquisition (SCADA) system is a type of industrial control system (ICS) that typically monitors and controls different types of processes. SCADA systems often are associated with large scale processes that can include multiple sites, and occur over large distances. One type of process that may be monitored is an industrial process and another type of process involves electrical power and distribution networks. Other examples of processes are possible.

An environment or area that is monitored by a SCADA system is sometimes broken into sub-components and these sub-components may further be broken down into other components. For example, an electrical distribution system may include substations and each substation may be broken down into voltage levels and bays. The bays may themselves include individual pieces of equipment, and the individual pieces of equipment may further include still further elements. Intelligent Electronic Devices (IEDs) are associated with various areas or pieces of equipment and monitor and/or control the areas/pieces of equipment.

SCADA systems must be configured so that users can monitor and/or control various pieces of equipment. Such configuration requires a significant amount of effort that often utilizes the same information that is entered in multiple places and in different formats. The duplicated information is difficult to keep synchronized and expensive to create, verify and maintain. To mention a few examples, various pieces of information may be entered in IEDs, the substation SCADA, substation planning tools, and system planning tools. Often spreadsheets or databases are used to store the point lists and keep track of the mapping to different, physical systems. SCADA systems include SCADA “points” which are input and or output typed values (e.g., Boolean, integer, string, or other values). Example SCADA points from an electrical substation SCADA system include current or voltage measurements, control points for opening or closing switches, control points for tap change position, or calculated values. Other examples are possible. SCADA engineers need to determine what physical equipment a SCADA point is related.

As can be appreciated, these previous approaches are time-consuming and error prone. Higher level systems, such as distribution management, outage management, and so forth, also need information from the SCADA system but often do not know which SCADA point has the information they need. As a result of the above-identified shortcomings, user dissatisfaction has developed with these previous approaches.

### BRIEF DESCRIPTION OF THE INVENTION

The present approaches reduce the time and cost of configuring SCADA systems, for example, SCADA systems associated with electrical distribution systems. Existing information from network planning software and substation IEDs can be reused to reduce the amount of data entry required. SCADA engineers can work with a model of the substation equipment rather than a list of point names which simplifies SCADA configuration.

In many of these embodiments, an electronic representation of a network and at least one equipment at the network is received. Intelligent electronic device (IED) information describing at least one IED is received. The at least one IED has an associated plurality of logical IED nodes. A map is created that associates the at least one equipment to an instance of a selected one of the plurality of logical IED nodes. A configuration interface is created and is based upon the electronic representation of the network, IED information and/or the map. The IED information and the configuration interface are generated automatically.

In one aspect, the configuration interface is a software program. In another aspect, the configuration interface is a configuration file (e.g., computer file). In one example, the configuration file includes textual information.

In another aspect, the IED information includes information such as a model number and measurement that an IED is capable of making. In other examples, the configuration interface is transmitted to a SCADA system. In yet other examples, the SCADA system automatically configures itself according to the configuration interface. In still other examples, the SCADA system is manually configured according to the configuration interface.

In other of these embodiments, an apparatus that is configured to facilitate interfacing between a user and a supervisory control and data acquisition (SCADA) program includes an operational interface and a processor. The operational interface includes an input and an output. The input is configured to receive an electronic representation of a network and at least one equipment on the network. The input is also configured to receive intelligent electronic device (IED) information describing one or more IEDs. The one or more IEDs have associated with them a plurality of logical IED nodes.

The processor is coupled to the operational interface and is configured to create a map that associates the at least one equipment to an instance of a selected one of the plurality of logical IED nodes. The processor is further configured to create a configuration interface. The configuration interface is based upon at least one of the electronic representation of the network and the equipment on the network and the IED information. The configuration interface is generated automatically and presented at the output.

### BRIEF DESCRIPTION OF THE DRAWINGS

For a more complete understanding of the disclosure, reference should be made to the following detailed description and accompanying drawings wherein:

FIG. 1 comprises a block diagram of a system for building a configuration file for use by a SCADA system according to various embodiments of the present invention;

FIG. 2 comprises a block diagram of a portion of a system for building a configuration file for a SCADA system according to various embodiments of the present invention;

FIG. 3 comprises a flowchart for an approach for building a configuration file for a SCADA system according to various embodiments of the present invention; and

FIG. 4 comprises an apparatus for building a configuration file for a SCADA system according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The approaches described herein provide a configuration interface (e.g., a software program, a configuration file) to and for use by a SCADA system (e.g., a SCADA program). The SCADA system may automatically use the configuration interface to configure itself. Alternatively, a user may manually use the information to configure the SCADA system. As used herein, a SCADA system (or program) includes a user interface (e.g., a graphical user interface (GUI) with graphics, control icons, and/or values that are measured). The SCADA system allows the user to monitor or control various equipment in a network or area. The SCADA system may be implemented as hardware, software, or combinations of hardware and software.

As described herein, particular equipment is mapped to instances of IED logical nodes. A logical node is a list of well organized and named information about a piece of equipment. Each logical node is defined by required and optional components typically in a specification such as International Electrotechnical Commission (IEC) 61850. As an IED is defined, instances of Logical nodes based on these definitions are specified to store actual equipment values for an actual piece of equipment. For example, an instance of an IED logical node for a particular IED numbered 101 associated with a circuit breaker may include a XCBR (circuit breaker) logical node and include information or fields associated with circuit breakers (e.g., Circuit Breaker “Position”). In the approaches described herein, this instance is mapped to a particular physical circuit breaker that is represented in a electrical network model.

In some aspects, after the configuration interface is configured an object builder walks the electrical network model to accomplish various tasks. For example, the object builder creates SCADA points and objects (if supported by the SCADA system) based on the physical equipment and automatically populates point address information. SCADA “points” have been described above. SCADA objects are logical groupings of SCADA points to facilitate re-use and organization in configuring SCADA screens, logging, alarming and so forth. By “point address information” it is meant the address/location of a point in the IED. The object builder also may configure the SCADA system to communicate with the IEDs. This is accomplished by configuring the communication system in the SCADA with IED information and point address information (e.g. IP Address, Point addresses, to mention two examples). Further, the object builder may create one line diagrams in the SCADA. By “one line” diagrams, it is meant a simplified graphical representation of the components and power flow of a given system/substation. The one-line diagrams may be used to view and change the current state (measurements, switch states) of the physical equipment through SCADA points.

The object builder may also provide configuration navigation between the one line diagrams and other SCADA screens. The object builder may additionally configure SCADA alarms from limit information on the attributes in the equipment model. For example, one alarm may relate to the minimum line voltage for a output line (e.g., feeder for a neighborhood) set in the equipment model would be configured as minimum value alarm in the SCADA on the SCADA point that corresponds to the line voltage measured by a device. In another example, an alarm may relate to the maximum transformer temperature. These alarms may be presented to users.

Communication of relevant SCADA points back to the network model is configured so that higher level systems can access physical equipment points without needing to know the configuration details. For example, a distribution management system (DMS) may need to know if a particular circuit breaker is open or closed. After this step is complete, the DMS can query the circuit breaker's state value in the electrical network model without knowing the SCADA point name or the IED communication details. To give one example, circuit breaker 1 (CBR1) on the outgoing feeder is controlled by IEDA in the Village substation. The current switch state is stored in the IED as CBR1.XCBR.State. The substation SCADA periodically reads this value from the IED and stores it in the VillageSubstation.Bay1.CBR1.Pos. A DMS system can read the SCADA connection information and point address from the electrical network model (with the mapping information as described herein).

After the initial substation configuration is complete, the approaches described herein can be re-executed to ensure that the SCADA configuration always matches the electrical network model in system planning tools.

The approaches described herein work with register-based protocols and model-based protocols. The approaches described herein are also optimized to take advantage of model based protocols because the mapping step is considerably simplified and can be done at an equipment level, rather than a point level.

The distributed network protocol (DNP) is an example of a register-based protocol and each register needs to be mapped to an equipment property. The International Electrotechnical Commission (IEC) 61850 protocol is an example of a model-based protocol and equipment can be mapped directly to logical nodes which are a collection of attributes. For example, a circuit breaker or re-closer in the electrical network model would be mapped to a XCBR logical node in, for example, according to a IEC 61850 compliant IED.

In other advantages of the present approaches and in a system having multiple electrical substations (e.g., each substation with circuit breakers, switches and other electrical equipment), after one substation is configured the entire configuration can be duplicated as starting point for other similar substations. The present approaches simplify the setup and maintenance of SCADA point lists and the mapping to IEDs and other system. The present approaches automate portions of substation SCADA configuration, points, objects, communication devices, alarming, screens, and navigation.

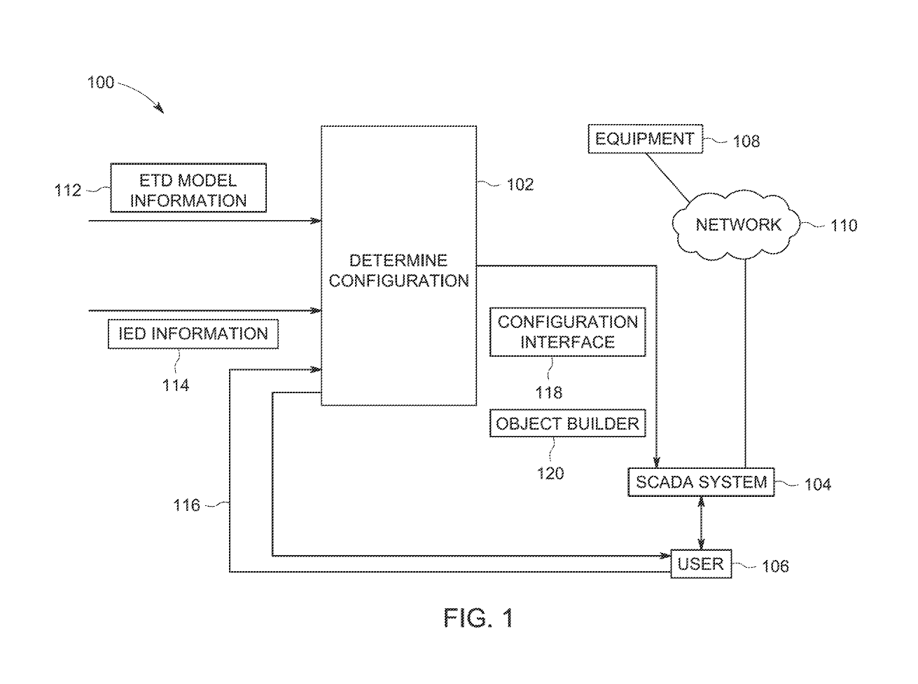

Referring now to FIG. 1, one example of a system 100 for building a configuration file for use by a SCADA system 104 is described. It will be appreciated that the system of FIG. 1 includes various modules and these modules can be implemented as various combinations of hardware or software, for example, as computer instructions that are executed on a general purpose processing device such as a microprocessor.

The system 100 includes a determine configuration module 102 that builds a configuration interface 118 that may be used by the SCADA system 104. A user 106 uses the SCADA system 104 to determine information, control, or monitor, equipment 108 on network 110. The determine configuration module 102 receives Electronic Transmission and Distribution (ETD) Model information 112, IED information 114, and manual interactions 116 to map and produce a configuration interface 118. The configuration interface 118 may be manually used to configure the SCADA system 104. Alternatively, an object builder 120 may automatically configure the SCADA system. The object builder 120 may be implemented as an combination of hardware and software to implement the object builder functions described herein.

The ETD Model information 112 specifies equipment and connections in a network. For example, an electrical line may be connected between points A and B and this may be connected to a transformer. The ETD Model information 112 may be implemented according to any appropriate data structure, in one example.

The IED information 114 includes information about particular IEDs such as an identifier of the IED, an IED model number, functionality of the IED, electrical connections of the IED with other elements, or other attributes. The IED information 114 may be implemented according to any appropriate data structure, in one example.

In some aspects, the object builder 120 walks the electrical network model to accomplish various tasks. For example, the object builder 120 creates SCADA points and objects (if supported by the SCADA system 104) based on the physical equipment and populates point address information. The object builder 120 also may configure the SCADA system 104 to communicate with the IEDs. Further, the object builder 120 may create one line diagrams in the SCADA system.

The object builder 120 may additionally provide configuration navigation between the one line diagrams and other SCADA screens. The object builder 120 may also configure SCADA alarms from limit information on the attributes in the equipment model. The function of SCADA alarms is to notify users of abnormal or flagged conditions in the SCADA data or process.

In another example of the operation of the system of FIG. 1, the ETD model information 112 is received. Intelligent electronic device (IED) information 114 describing one or more IEDs is received. The IEDs have an associated plurality of logical IED nodes. A map is created by the determine configuration module 102 that associates the at least one equipment to an instance of a selected one of the plurality of logical IED nodes. The configuration interface 118 is created and is based upon at least one of the electronic representation of the network and the equipment on the network. The IED information 114 and the configuration interface 118 are generated automatically and can be sent to the SCADA system 104.

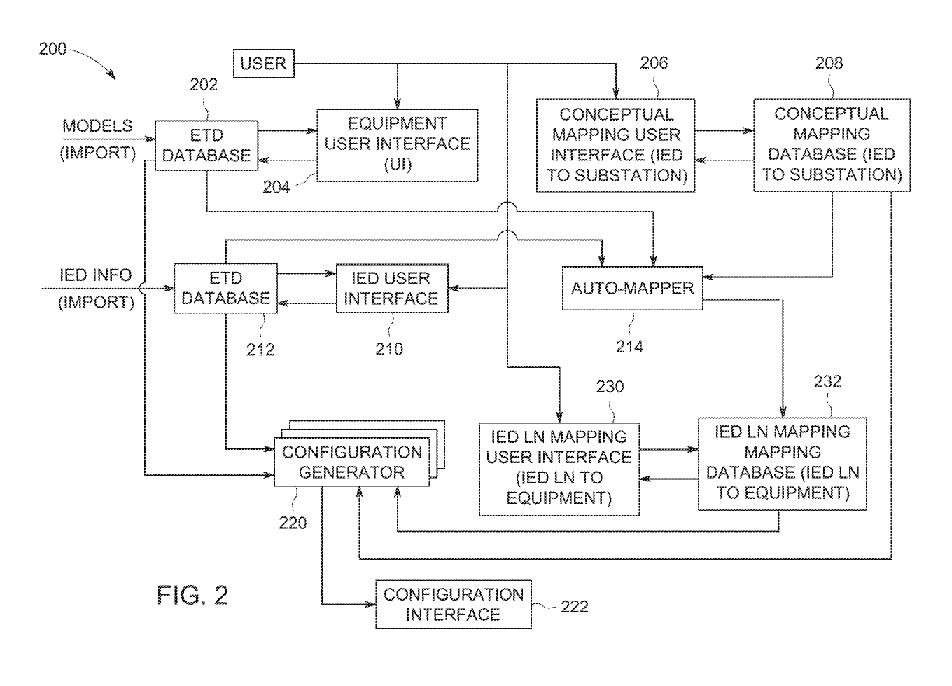

Referring now to FIG. 2, one example of a system 200 for creating a configuration interface is described. For example, this may be the determine configuration module 102 of FIG. 1. It will be appreciated that the system of FIG. 2 includes various modules and these modules can be implemented as various combinations of hardware or software, for example, as computer instructions that are executed on a general purpose processing device such as a microprocessor. Additionally, the example of FIG. 2 includes various databases and these databases can be implemented as a single or multiple types of data storage locations (e.g., computer memories, disk drives, to mention two examples).

The system 200 includes an Electronic Transmission and Distribution (ETD) database 202. The ETD database 202 stores information regarding a network and equipment used in the network, and the connections. For example, wire goes from point A to point B and is connect to a transformer. The ETD database 202 can import information from external sources or have the information directly entered by a user.

The system 200 also includes an equipment user interface 204. The equipment user interface 204 handles user requests regarding the equipment. For example, attributes of equipment in the network can be viewed and its characteristics changed.

The system 200 additionally includes a conceptual mapping user interface 206. The conceptual mapping user interface 206 connects IEDs to a conceptual location in the network. For example, a particular IED belongs at a certain place on the map of the system (i.e., a conceptual location, not a physical location). For example, an IED may be conceptually located at a particular piece of equipment, at a particular equipment bay (that includes multiple pieces of equipment), or at a particular electrical substation (that includes a plurality of bays).

The system 200 also includes a conceptual mapping database 208, an IED mapping user interface 210, and an IED database 212. The conceptual mapping database 208 stores the mappings of the IEDs to conceptual locations. The IED mapping user interface 210 allows user to view IEDs in the system and allows the user to modify the IED information if the information is not accurate. The user may also need to add new IEDs manually. The IED database 212 is where the IED information is stored. IED network information (e.g., IP addresses, dataset or reports) can also be entered.

The system includes a IED logical node (LN) user interface 230 and a IED LN mapping database 232. The IED LN user interface 230 allows a user to view automatically determined mappings (generated by an auto-mapper 214) and validate these mappings. A manual mapping of IED logical nodes to equipment may also be entered. Manual mappings can show a filtered view of available IEDs based upon equipment type and location, and the IED conceptual location and IED logical node type (e.g., XCBR to recloser). The IED LN mapping database 232 stores the equipment to IED LN mappings and instances.

The system 200 further includes an auto-mapper 214 that creates a mapping between IED logical nodes and equipment. Logical nodes relate to particular types of information relevant to types of equipment. Instances of logical nodes store this information, for instance, in a predetermined data structure. For example, an instance of an IED logical node for a particular IED numbered 10145689 is a XCBR (circuit breaker) logical node that includes/stores certain types of information related to a circuit breaker. This IED instance is mapped (automatically or manually) to a particular physical circuit breaker that is represented in the ETD model.

In this respect, the auto-mapper 214 may create the IED logical node-to-equipment mapping automatically. For example, it may look at the common names of the equipment in the ETD model, the names of the IED logical nodes or IEDs, or at the conceptual locations of the equipment in the network to see if an automatic mapping from an instance of an IED logical node to a piece of equipment can potentially be made. Alternatively, the user may manually make the mappings using the IED logical node mapping interface 216. Once the mapping is determined, an auto-mapper data base stores the mappings.

The configuration generator 220 generates a configuration interface 222. The configuration interface 222 is used in the SCADA system to configure the SCADA system either automatically (using an object builder) or manually. The configuration generator 220 receives IED logical node mappings (from the IED LN mapping database 232), IED information (from the IED database 212), ETD information (from the ETD database 202), and IED conceptual location information (from the conceptual mapping database 208) and creates the configuration interface 222. In this respect, the configuration generator 220 may be programmed to receive this information, identify certain types of information, and format the processed information in a format that is compatible with a SCADA system.

One example of the configuration interface 222 is a configuration file. In this case, the file may include textual information. For example and for a configuration interface 222 that relates to an electrical substation, the textual information may include a description of the substation, where the substation is located, pieces of equipment in the substation, voltage levels related to the equipment, bays in the substation (and equipment in the bays), IEDs at the substation, and information related to the IEDs. Alternatively, the configuration interface 222 could also be implemented as a software program that the SCADA system can utilize.

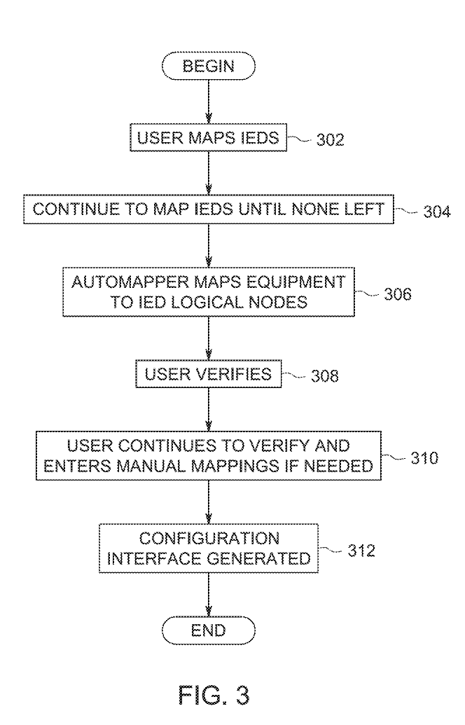

Referring now to FIG. 3, one example of an approach for producing a particular type of configuration interface is described. At step 302, the user maps the IEDs to the substation area. For example, the user indicates, using a particular graphical user interface (GUI), that a particular IED is logically associated with a particular piece of equipment, bay, or substation.

At step 304, the user continues to map the IEDs until there are no more unmapped IEDs. At step 306, an auto-mapper (e.g., the auto-mapper 214 of FIG. 2) intelligently maps equipment to IED logical nodes.

At step 308, the user verifies that the automatic mappings are correct using, for example, a GUI (e.g., the conceptual mapping user interface 206 of FIG. 2) and enters the manual mappings if needed, again using an appropriate GUI. At step 310, the user continues to verify the automatic mappings and to enter manual mappings until satisfied.

At step 312, a configuration interface is generated. As mentioned, the configuration interface may be an executable set of computer instructions or a configuration file (e.g., a computer file including textual information) to mention two examples. The configuration interface can now be utilized to configure the SCADA system. By “configuring” the SCADA system, it is meant the building of SCADA screens representing actual conditions in a process or substation as well as the configuration of alarms, storage of data, trending and so forth.

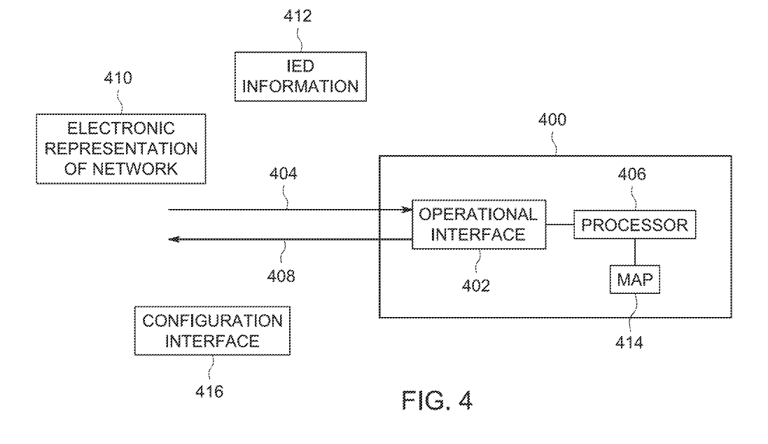

Referring now to FIG. 4, one example of an apparatus 400 for creating a configuration interface is described. The apparatus 400 includes an operational interface 402 and a processor 404. The operational interface 402 includes an input 406 and an output 408. The input 406 is configured to receive an electronic representation of a network 410 (e.g., the ETD Model Information described elsewhere herein) and intelligent electronic device (IED) information 412 describing at least one IED. The at least one IED having associated a plurality of logical IED nodes.

The processor 404 coupled to the operational interface 402 and is configured to create a map 414 that associates the at least one equipment to an instance of a selected one of the plurality of logical IED nodes. This process of mapping will be a combination of automatically looking for associations between the electrical model equipment names and data attributes and the Logical Nodes and attributes in the IED database. The processor 404 is configured to create a configuration interface 416. The configuration interface 416 is based upon at least one of the electronic representation of the network 410 and the IED information 412. The configuration interface 416 is generated automatically and presented at the output 408.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of facilitating an interface between a user and a supervisory control and data acquisition (SCADA) system, the method comprising:
receiving an electronic representation of a network and at least one equipment at the network;
receiving intelligent electronic device (IED) information describing at least one IED, the at least one IED having an associated plurality of logical IED nodes;
creating a map that associates the at least one equipment to an instance of a selected one of the plurality of logical IED nodes;
creating a configuration interface, the configuration interface being based upon at least one of the electronic representation of the network, the IED information, and the map, the configuration interface being generated automatically.

2. The method of claim 1 wherein the configuration interface is a software program.

3. The method of claim 1 wherein the configuration interface is a configuration file.

4. The method of claim 3 wherein the configuration file includes textual information.

5. The method of claim 1 wherein the IED information comprises information selected from the group consisting of: a model number and a measurement that the at least one IED is capable of making.

6. The method of claim 1 further comprising transmitting the configuration interface to a SCADA system.

7. The method of claim 6 further comprising the SCADA system automatically configuring itself according to the configuration interface.

8. The method of claim 7 further comprising manually configuring a SCADA system according to the configuration interface.

9. An apparatus that is configured to facilitate interfacing between a user and a supervisory control and data acquisition (SCADA) system, the apparatus comprising:
an operational interface with an input and an output, the input configured to receive an electronic representation of a network and at least one equipment at the network and receive intelligent electronic device (IED) information describing at least one IED, the at least one IED having an associated plurality of logical IED nodes; and
a processor coupled to the operational interface, the processor configured to create a map that associates the at least one equipment to an instance of a selected one of the plurality of logical IED nodes, the processor configured to create a configuration interface, the configuration interface being based upon at least one of the electronic representation of the network, the IED information, and the map, the configuration interface being generated automatically and presented at the output.

10. The apparatus of claim 9 wherein the configuration interface is a software program.

11. The apparatus of claim 9 wherein the configuration interface is a configuration file.

12. The apparatus of claim 11 wherein the configuration file includes textual information.

13. The apparatus of claim 9 wherein the IED information comprises information selected from the group consisting of: a model number and a measurement that the at least one IED is capable of making.

14. The apparatus of claim 9 wherein the processor is further configured to transmit the configuration interface to a SCADA system at the output.
